(19) United States
(12) Patent Application Publication
(10) Pub. No.: US 2026/0077605 A1
(43) Pub. Date: Mar. 19, 2026

(54) PRINTING DEVICE AND PRINTING METHOD

(71) Applicant: MIMAKI ENGINEERING CO., LTD., Nagano (JP)

(72) Inventor: Yuichi Narishima, Nagano (JP)

(73) Assignee: MIMAKI ENGINEERING CO., LTD., Nagano (JP)

(21) Appl. No.: 19/110,091

(22) PCT Filed: Oct. 6, 2023
(86) PCT No.: PCT/JP2023/036620

§ 371 Date: Mar. 9, 2025

(30) Foreign Application Priority Data
Oct. 7, 2022 (JP) 2022-162588

(51) Int. Cl. B41J 11/00

(52) U.S. Cl. CPC B41J 11/00212; B41J 11/00214; B41J 11/00218

(57) ABSTRACT

Provided are a printing device and a printing method. A printing device 10 includes an ink ejection head 40 that ejects a photocurable ink onto a medium 22 while relatively moving with respect to the medium 22 in a main scanning direction Y, and an irradiation unit 32 that irradiates the medium 22 with light while relatively moving together with the ink ejection head 40. The irradiation unit 32 includes a plurality of LEDs 34 arranged in a sub-scanning direction X intersecting with the main scanning direction Y. The printing device 10 further includes an irradiation control unit 60 that controls the irradiation unit 32 such that turning-on and turning-off of irradiation with the plurality of LEDs 34 are repeatedly performed in a predetermined order during one cycle in which the ink ejection head 40 and the irradiation unit 32 relatively move in the main scanning direction Y.

### TECHNICAL FIELD

The present invention relates to a printing device and a printing method.

### BACKGROUND ART

Conventionally, there has been developed a printing device that ejects a photocurable ink onto a recording medium and irradiates the ink landed on the recording medium with ultraviolet rays or the like to cure the ink to form an image.

As described in Patent Literature 1, a printing device using such a photocurable ink includes an irradiation unit that emits ultraviolet rays for curing the ink. The irradiation unit is provided in a carriage unit equipped with a nozzle head that ejects an ink.

### CITATION LIST

### Patent Literature

Patent Literature 1: Japanese Patent No. 2015-74161

### SUMMARY OF INVENTION

### Technical Problems

The irradiation unit applies a load to the printing device by emitting light for sufficiently curing the ink landed on the recording medium. In order to reduce the load on the printing device by the irradiation unit, it is required to reduce a peak value of a current or voltage required for light irradiation.

Therefore, an object of the present invention is to provide a printing device and a printing method by which a peak value of a current or voltage required for light irradiation can be reduced while an influence on curing of an ink landed on a recording medium can be suppressed.

### Solutions to Problems

A printing device of a first aspect of the present invention includes: an ink ejection means for ejecting a photocurable ink onto a recording medium while relatively moving with respect to the recording medium in a first direction; and an irradiation means for irradiating the recording medium with light while relatively moving together with the ink ejection means, in which the irradiation means includes a plurality of light irradiation elements arranged in a second direction intersecting with the first direction, and in which the printing device further includes an irradiation control means for controlling the irradiation means such that turning-on and turning-off of irradiation with the plurality of light irradiation elements are repeatedly performed in a predetermined order during one cycle in which the ink ejection means and the irradiation means relatively move in the first direction.

According to the present configuration, the photocurable ink is ejected to the recording medium while relatively moving with respect to the recording medium in the first direction. The plurality of light irradiation elements that emit the light for curing the ink are arranged in the irradiation means in the second direction intersecting with the first direction, and the irradiation means relatively moves together with the ink ejection means with respect to the recording medium in the first direction.

In the present configuration, the turning-on and the turning-off of the irradiation with the plurality of light irradiation elements are repeatedly performed in a predetermined order during one cycle in which the ink ejection means and the irradiation means relatively move in the first direction. That is, light irradiation for curing the ink landed on the recording medium is performed by shifting the timing of the turning-on and the turning-off of the plurality of light irradiation elements. Thus, by the present configuration, a peak value of a current or voltage required for light irradiation can be reduced while an influence on curing of the ink landed on the recording medium can be suppressed.

As a printing device of a second aspect, in the printing device of the first aspect, the irradiation control means may control the irradiation means such that the turning-on and the turning-off of the irradiation with the plurality of light irradiation elements are repeatedly performed in a predetermined order in the second direction.

As a printing device of a third aspect, in the printing device of the first or second aspect, the irradiation control means may turn on the irradiation with another light irradiation element after elapse of a first time from when the irradiation with a predetermined light irradiation element is turned on, turn off the irradiation with the predetermined light irradiation element after elapse of a second time from when the irradiation with the predetermined light irradiation element is turned on, and turn on the irradiation with the predetermined light irradiation element after elapse of a third time from when the irradiation with the predetermined light irradiation element is turned off.

As a printing device of a fourth aspect, in the printing device of the third aspect, the first time may be shorter than each of the second time and the third time, and the second time may be longer than the third time.

As a printing device of a fifth aspect, in the printing device of any one of the first to fourth aspects, the irradiation control means may not generate a time period in which all of the plurality of light irradiation elements are simultaneously turned off.

As a printing device of a sixth aspect, in the printing device of any one of the first to fifth aspects, the plurality of light irradiation elements may be divided into a plurality of groups, and the irradiation control means may control the irradiation with the light irradiation elements for each of the groups.

As a printing device of a seventh aspect, in the printing device of the sixth aspect, the irradiation control means may turn on the irradiation with the light irradiation elements included in another group adjacent to a predetermined group after elapse of a predetermined time from when the irradiation with the light irradiation elements included in the predetermined group is turned on.

In a printing method of an eighth aspect, an ink ejection means ejects a photocurable ink onto a recording medium while relatively moving with respect to the recording medium in a first direction, an irradiation means irradiates the recording medium with light while relatively moving together with the ink ejection means, the irradiation means includes a plurality of light irradiation elements arranged in a second direction intersecting with the first direction, and the irradiation means is controlled such that turning-on and turning-off of irradiation with the plurality of light irradiation elements are repeatedly performed in a predetermined order during one cycle in which the ink ejection means and the irradiation means relatively move in the first direction.

### Effect of the Invention

According to the present invention, it is possible to provide a printing device and a printing method by which a peak value of a current or voltage required for light irradiation can be reduced while an influence on curing of an ink landed on a recording medium can be suppressed.

### BRIEF DESCRIPTION OF THE DRAWINGS

FIG. 1 is a schematic configuration diagram of a printing device according to an embodiment.

FIG. 2 is an external view of a carriage according to the embodiment, in which (A) is a front view and (B) is a bottom view.

FIG. 3 is a cross-sectional view of an irradiation unit according to the embodiment.

FIG. 4 is a functional block diagram of the irradiation unit according to the embodiment.

FIG. 5 is a timing chart of turning-on and turning-off of a conventional irradiation unit.

FIG. 6 is a timing chart of turning-on and turning-off of the irradiation unit according to the embodiment.

FIG. 7 is a diagram showing a consumption current of the irradiation unit, in which (A) shows a consumption current of the conventional irradiation unit, and (B) shows a consumption current of the irradiation unit of the embodiment.

FIG. 8 is a schematic diagram showing an average illuminance distribution according to the embodiment.

### DESCRIPTION OF EMBODIMENTS

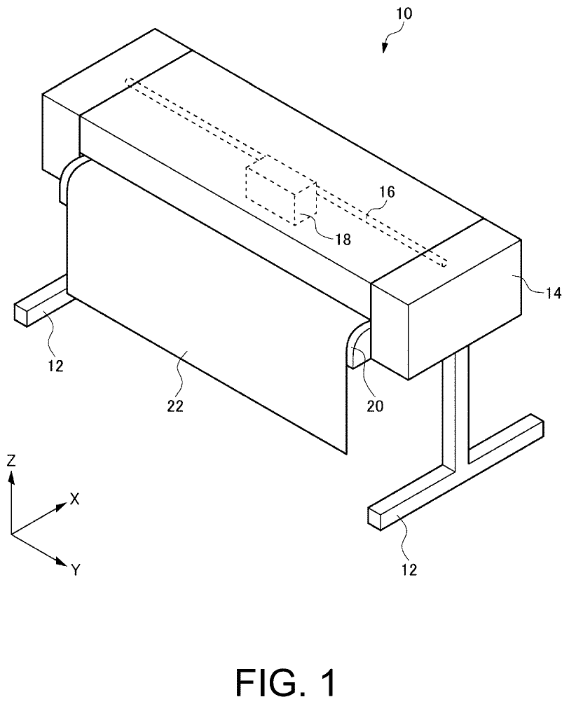

Hereinafter, a printing device 10 according to an embodiment of the present invention will be described with reference to the drawings. FIG. 1 is a schematic overall view of the printing device 10 according to the present embodiment. The printing device 10 of the present embodiment is a so-called ink jet printer as will be described below.

As shown in FIG. 1, the printing device 10 includes a leg 12 installed on the floor, and a main body 14 disposed above (in a Z direction) the leg 12. The main body 14 includes a guide rail 16, a carriage 18, a platen 20, and the like.

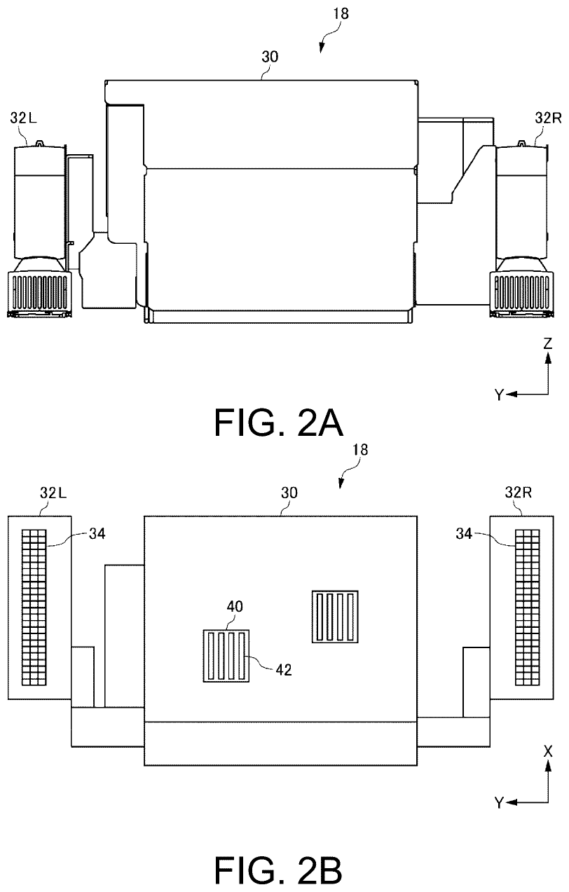

The guide rail 16 extends in a left-right direction (main scanning direction Y) of the printing device 10 and guides the movement of the carriage 18 in the scanning direction. In the carriage 18, one or a plurality of ink ejection heads 40 (see FIG. 2) that eject an ink to a recording medium (hereinafter referred to as “medium”) 22 are mounted, and the ink is ejected to the medium 22 while the carriage moves in the main scanning direction Y along the guide rail 16. In the following description, a first direction in which the carriage 18 relatively moves with respect to the medium 22 is referred to as the main scanning direction Y, and a second direction intersecting with (orthogonal to in the present embodiment) the main scanning direction Y is referred to as a sub-scanning direction X.

The platen 20 is a mounting stand on which the medium 22 is mounted. The medium 22 mounted on the platen 20 is transported in the sub-scanning direction X by a transporting mechanism. As the medium 22, a sheet-like recording medium such as paper, a vinyl chloride film, a rubber sheet, or fabric can be applied.

FIG. 2 is an external view of the carriage 18 of the present embodiment. FIG. 2(A) is a front view of the carriage 18. FIG. 2(B) is a bottom view of the carriage 18. The carriage 18 has a plurality of ink ejection heads 40 mounted inside a carriage body 30.

A nozzle 42 for ejecting the ink from the ink ejection heads 40 to the medium 22 is exposed on a bottom surface of the carriage body 30. The ink ejected from the ink ejection head 40 is a photocurable ink, and is cured using ultraviolet rays in the present embodiment. Thus, the carriage 18 includes irradiation units 32 for emitting light (ultraviolet light) to cure the ink landed on the medium 22.

The irradiation units 32 of the present embodiment are provided on a pair of left and right sides of the carriage 18 in the main scanning direction Y with the ink ejection head 40 interposed therebetween. Thus, each of the irradiation units 32 irradiates the medium 22 with light while relatively moving together with the ink ejection head 40. In the following description, the irradiation units 32 provided on the left and right sides of the carriage 18 are distinguished from each other by adding R or L to the end of the irradiation unit.

Furthermore, in the irradiation unit 32 of the present embodiment, a plurality of light irradiation elements (hereinafter referred to as “LEDs”) 34 is arranged in the main scanning direction Y and the sub-scanning direction X. In the irradiation unit 32 of the present embodiment, a total of 84 LEDs 34 are arranged in 3 columns in the main scanning direction Y and 28 rows in the sub-scanning direction X. The number and arrangement of the LEDs 34 are merely examples, and it is sufficient that the light amount capable of curing the ink landed on the medium 22 can be emitted.

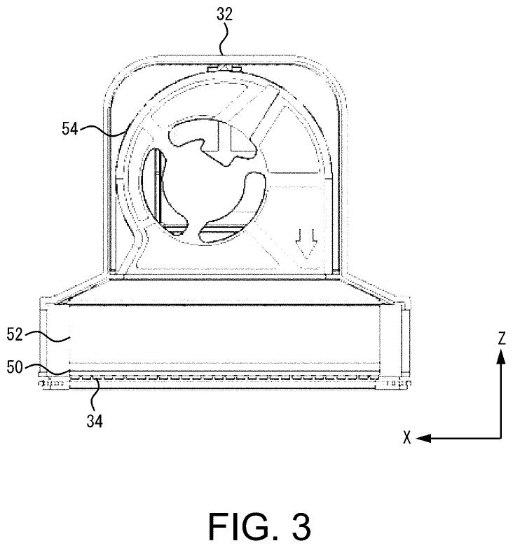

FIG. 3 is a cross-sectional view of the irradiation unit 32 according to the embodiment. The irradiation unit 32 is provided with an LED substrate 50 on which the LEDs 34 are arranged. The LED substrate 50 generates heat together with light irradiation with the LEDs 34. For this reason, a heat sink 52 for heat discharge integrated with the LED substrate 50 is provided above the LED substrate 50. Then, a fan 54 is provided above the heat sink 52 to cool the heat sink 52. As described above, in the irradiation unit 32 of the present embodiment, air-cooling is used to cool the LEDs 34 that have generated heat, but the present invention is not limited thereto, and the LEDs 34 may be cooled by water cooling.

The shapes, sizes, and the like of the LED substrate 50, the heat sink 52, and the fan 54 are appropriately optimized according to the number and arrangement of the LEDs 34 included in the irradiation unit 32.

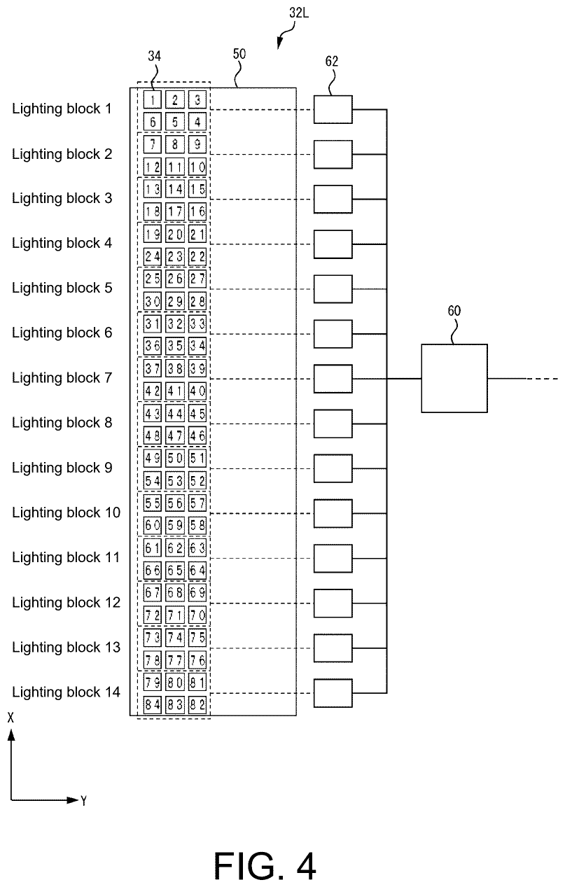

FIG. 4 is a functional block diagram of the irradiation unit 32 according to the present embodiment. The printing device 10 of the present embodiment includes an irradiation control unit 60 and a plurality of drive ICs 62. Although the irradiation unit 32L is illustrated in FIG. 4, the LEDs 34 of the irradiation unit 32R are similarly connected to the irradiation control unit 60 via the drive ICs 62.

The irradiation control unit 60 performs drive control of the LEDs 34 by outputting a drive signal for turning on or off the LEDs 34 to the drive ICs 62.

The irradiation control unit 60 may perform different kinds of drive control between the irradiation unit 32R and the irradiation unit 32L according to the position and moving direction of the carriage 18 in the main scanning direction Y. The position of the carriage 18 in the main scanning direction Y is determined by the irradiation control unit 60 on the basis of a signal from an encoder. For example, one of the irradiation unit 32R and the irradiation unit 32L is driven according to the moving direction of the carriage 18 with respect to the main scanning direction Y, or the irradiation unit 32R or the irradiation unit 32 L is driven when the carriage 18 reaches a predetermined position in the main scanning direction Y.

The drive ICs 62 turn on or off the connected LEDs 34 on the basis of the drive signal output from the irradiation control unit 60. The LEDs 34 of the present embodiment are virtually divided into a plurality of groups in the sub-scanning direction X. That is, the irradiation control unit 60 of the present embodiment outputs a drive signal for controlling the irradiation with the LEDs 34 for each group to the drive ICs 62. The drive ICs 62 drive the LEDs 34 for each group on the basis of the drive signal from the irradiation control unit 60.

In the present embodiment, as illustrated in FIG. 4, the LEDs 34 are divided into groups each having the LEDs in 2 rows, that is, 6 LEDs. The number of LEDs 34 included in the group is not limited thereto. In the following description, a group is also referred to as a lighting block, and the groups are distinguished from each other by adding a number to the end of the group. That is, the plurality of LEDs 34 included in the irradiation unit 32L of the present embodiment are divided into groups of lighting blocks 1 to 14, and are driven for each lighting block by the 14 drive ICs 62. In addition, the plurality of LEDs 34 included in the irradiation unit 32R are divided into groups of lighting blocks 15 to 28, and are driven for each lighting block by the 14 drive ICs 62.

The irradiation control unit 60 of the present embodiment performs drive control of the LEDs 34 using pulse width modulation (PWM) control. In the present embodiment, the drive control of the LEDs 34 is performed by current control with a constant voltage, but the present invention is not limited thereto, and the drive control of the LEDs 34 may be performed by voltage control with a constant current.

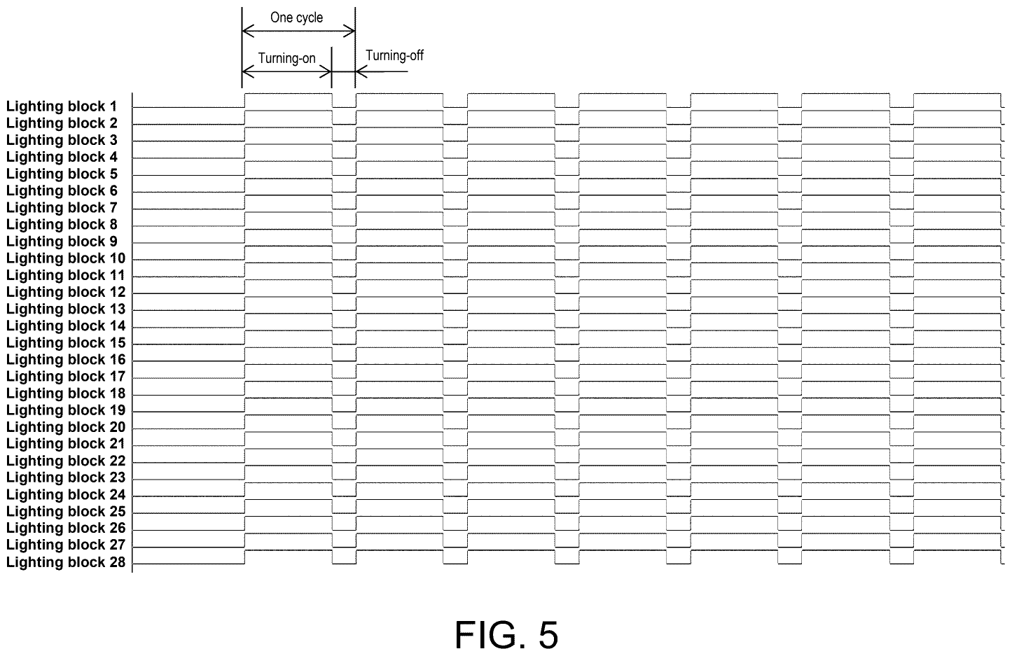

Here, FIG. 5 is a timing chart of the turning-on and the turning-off of a conventional irradiation unit 32. In the example of FIG. 5, the turning-on and the turning-off are repeatedly performed at the same timing for all the lighting blocks 1 to 28.

On the other hand, the irradiation control unit 60 of the present embodiment controls the irradiation unit 32 such that the turning-on and the turning-off of the irradiation with the plurality of LEDs 34 are repeatedly performed in a predetermined order during one cycle in which the carriage 18 relatively moves in the main scanning direction Y.

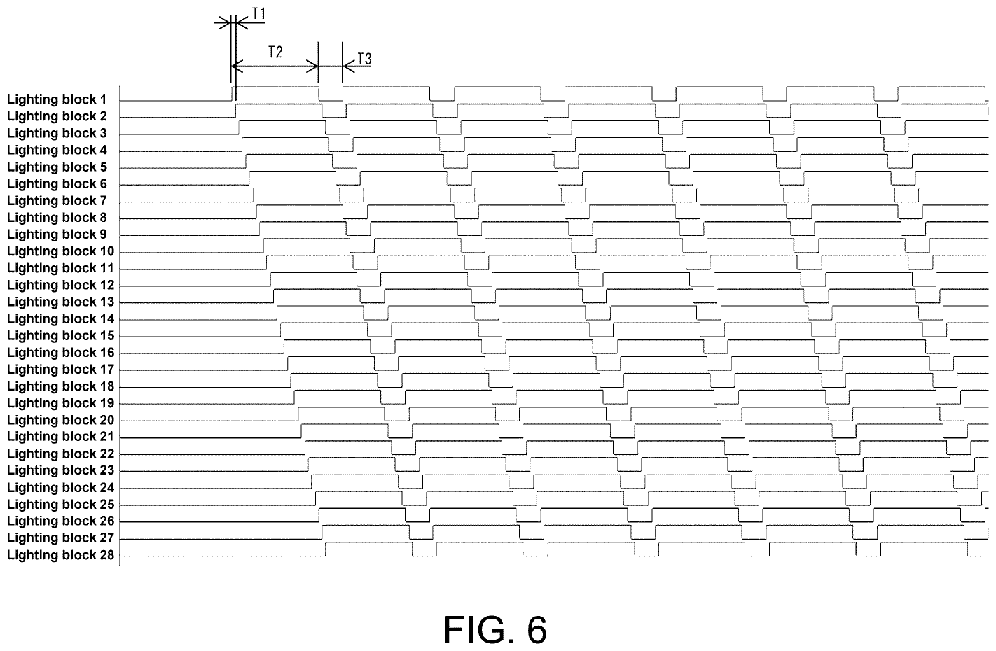

FIG. 6 is a timing chart of turning-on and turning-off of the irradiation unit 32 according to the present embodiment. As shown in FIG. 6, the irradiation control unit 60 of the present embodiment controls the irradiation unit 32 such that the turning-on and the turning-off of the irradiation with the plurality of LEDs 34 (lighting blocks) are repeatedly performed in a predetermined order in the sub-scanning direction X.

Specifically, the irradiation control unit 60 turns on the irradiation with another lighting block after elapse of a first time (hereinafter referred to as “interval time T1”) from when the irradiation with the predetermined lighting block is turned on. Then, the irradiation control unit 60 turns off the irradiation with the lighting block after elapse of a second time (hereinafter referred to as “turning-on time T2”) from when the irradiation with the lighting block is turned on, and turns on the irradiation with the lighting block after elapse of a third time (hereinafter referred to as “turning-off time T3”) from when the irradiation with the lighting block is turned off.

In the example of FIG. 6, the irradiation control unit 60 turns on the irradiation with the adjacent lighting block 2 after elapse of the interval time T1 from when the irradiation with the lighting block 1 is turned on. Then, the irradiation control unit 60 turns off the irradiation with the lighting block 1 after elapse of the turning-on time T2 from when the irradiation with the lighting block 1 is turned on, and turns on the irradiation with the lighting block 1 again after elapse of the turning-off time T3. Further, the irradiation control unit 60 turns on the irradiation with the lighting block 3 adjacent to the lighting block 2 after elapse of the interval time T1 from when the irradiation with the lighting block 2 is turned on, and performs the same up to the lighting block 28. As described above, in the drive control of the present embodiment, the turning-on and the turning-off of the irradiation are repeated with the timing shifted for each of the lighting blocks adjacent in the sub-scanning direction X.

Here, one cycle (turning-on and turning-off once) of the PWM control for the irradiation unit 32 needs to be sufficiently shorter than one cycle in which the carriage 18 moves in the main scanning direction Y. If one cycle of the PWM control is not sufficiently shorter than the movement cycle of the carriage 18, curing failure may occur in the ink landed on the medium 22.

The interval time T1 of the present embodiment is shorter than each of the turning-on time T2 and the turning-off time T3, and the turning-on time T2 is longer than the turning-off time T3. The reason why the turning-on time T2 is longer than the turning-off time T3 is to obtain sufficient illuminance for curing the ink. The same applies to the reason why the interval time T1 is shorter than the turning-on time T2 and the turning-off time T3, and if the interval time T1 is long, a sufficient illuminance for curing the ink cannot be obtained.

In addition, in the conventional drive control illustrated in FIG. 5, the turning-on and the turning-off of all the LEDs 34 are performed at the same timing. Therefore, a time period in which all the LEDs 34 are turned off is generated. On the other hand, in the drive control of the present embodiment, a time period in which all the plurality of LEDs 34 are turned off is not generated by shifting the timing of the turning-on of the LEDs 34. For example, referring to FIG. 6, even when the lighting block 1 is turned off, the other lighting blocks are turned on, and one of the blocks is always turned off. By such drive control of the present embodiment, it is possible to achieve both reduction of the peak current as compared with the conventional case and acquisition of sufficient illuminance for curing the ink.

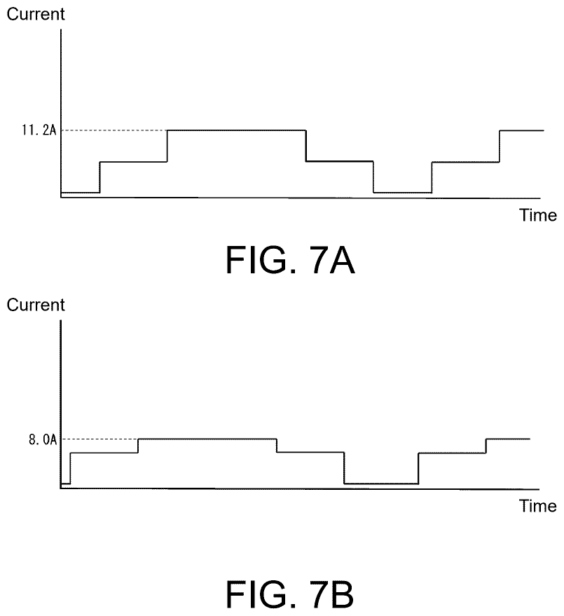

FIG. 7 is a diagram illustrating an example of a consumption current of the irradiation unit 32. FIG. 7(A) shows a consumption current of the conventional irradiation unit 32, and FIG. 7(B) shows a consumption current of the irradiation unit 32 of the present embodiment. The consumption current of the conventional irradiation unit 32 has a peak value of 11.2 A, while the consumption current of the irradiation unit 32 of the present embodiment has a peak value of 8.0 A. As described above, the peak value of the consumption current of the irradiation unit 32 of the present embodiment has been reduced by a significant difference as compared with the conventional case.

As shown in FIG. 6, as an example, the irradiation control unit 60 of the present embodiment turns on the irradiation with the lighting block 14 of the irradiation unit 32R after elapse of the interval time T1 from when the irradiation with the lighting block 15 of the irradiation unit 32L is turned on. Thus, the drive control by the left and right irradiation units 32R, 32L is prevented from overlapping, and the current peak value of the irradiation unit 32 can be reduced.

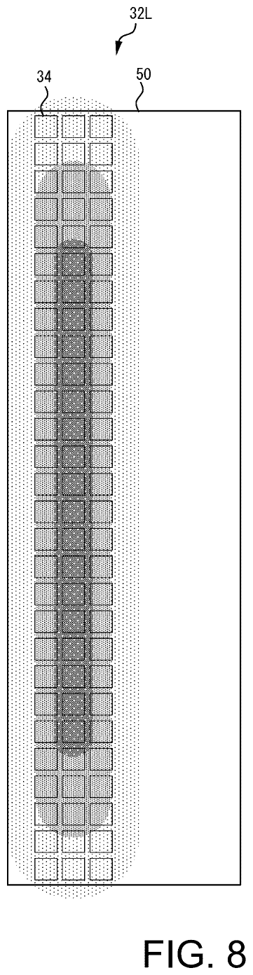

FIG. 8 is a schematic diagram showing an average illuminance distribution in the irradiation unit 32L of the present embodiment. FIG. 8 shows that the darker hatched region has a relatively higher illuminance. As shown in FIG. 8, the illuminance at the central portion of the irradiation unit 32L is higher than that at the periphery thereof. The central portion of the irradiation unit 32L is the same region as the region where the nozzles 42 that eject the ink are disposed in the carriage 18 (see FIG. 3). Thus, in the drive control of the present embodiment, the illuminance distribution suitable for curing the ink landed on the medium 22 is obtained, and the current peak value of the irradiation unit 32 can be reduced.

As described above, the printing device 10 of the present embodiment repeatedly performs the turning-on and the turning-off of the irradiation with the plurality of LEDs 34 in a predetermined order in the sub-scanning direction X during one cycle in which the carriage 18 relatively moves in the main scanning direction Y. That is, the printing device 10 of the present embodiment performs light irradiation for curing the ink landed on the medium 22 by shifting the timing of the turning-on and the turning-off of the plurality of LEDs 34 in the sub-scanning direction X. As a result, the printing device 10 of the present embodiment can lower the current peak value of the irradiation unit 32 as compared with the conventional case, and thus can reduce the peak value of a current required for light irradiation while an influence on curing of the ink landed on the medium 22 can be suppressed.

Although the present invention has been described with reference to the above embodiment, the technical scope of the present invention is not limited to the scope described in the above embodiment. Various modifications or improvements can be made to the above embodiment without departing from the gist of the invention, and a mode in which the modifications or improvements are made is also included in the technical scope of the present invention.

In the above embodiment, a mode in which the timing to turn on the irradiation is shifted for each lighting block has been described, but the present invention is not limited thereto. For example, instead of shifting the timing to turn on the irradiation for each lighting block, the timing to turn on the irradiation may be shifted for each of the LEDs 34 divided into a plurality of lighting blocks. Alternatively, the timing to turn on the lighting block may be shifted not in the order of the lighting block 1 to the lighting block 28 but in the order of the lighting block 28 to the lighting block 1, or the timing to turn on the lighting block 1 or the lighting block 14 at the end may be shifted from the lighting block 7 or the lighting block 8 at the central portion in that order. Instead of turning on the lighting block 29 of the irradiation unit 32R next to the lighting block 28 of the irradiation unit 32L, the lighting block of the irradiation unit 32L and the lighting block of the irradiation unit 32R may be turned on and off at the same timing.

In the above embodiment, a mode in which the drive control of the LEDs 34 is performed for each group (lighting block) including the predetermined number of LEDs 34 has been described, but the present invention is not limited thereto, and a mode in which the drive control is performed for each LED 34 without forming the LEDs 34 into a group may be used.

In the above embodiment, a mode in which the timing to turn on the plurality of LEDs 34 is shifted in the sub-scanning direction X has been described, but the present invention is not limited thereto, and the timing to turn on the plurality of LEDs 34 may be shifted in the main scanning direction Y. In this mode, the plurality of LEDs 34 may be virtually divided into a plurality of groups in the main scanning direction Y.

### Effects of Embodiment

(1) A printing device 10 of the present embodiment includes an ink ejection head 40 that ejects a photocurable ink onto a medium 22 while relatively moving with respect to the medium 22 in a main scanning direction Y, and an irradiation unit 32 that irradiates the medium 22 with light while relatively moving together with the ink ejection head 40, in which the irradiation unit 32 includes a plurality of LEDs 34 arranged in a sub-scanning direction X intersecting with the main scanning direction Y, and in which the printing device 10 further includes an irradiation control unit 60 that controls the irradiation unit 32 such that turning-on and turning-off of irradiation with the plurality of LEDs 34 are repeatedly performed in a predetermined order during one cycle in which the ink ejection head 40 and the irradiation unit 32 relatively move in the main scanning direction Y.

According to the present embodiment, the photocurable ink is ejected to the medium 22 while relatively moving with respect to the medium 22 in the main scanning direction Y. The plurality of LEDs 34 that emit the light for curing the ink are arranged in the irradiation unit 32 in the sub-scanning direction X intersecting with the main scanning direction Y, and the irradiation unit 32 relatively moves together with the ink ejection head 40 with respect to the medium 22 in the main scanning direction Y.

According to the present embodiment, the turning-on and the turning-off of the irradiation with the plurality of LEDs 34 are repeatedly performed in a predetermined order during one cycle in which the ink ejection head 40 and the irradiation unit 32 relatively move in the main scanning direction. That is, light irradiation for curing the ink landed on the medium 22 is performed by shifting the timing of the turning-on and the turning-off of the plurality of LEDs 34. Thus, a peak value of a current required for light irradiation can be reduced while an influence on curing of an ink landed on the medium 22 can be suppressed. In the present embodiment, the peak value of the current is reduced by performing the current control in which the voltage is constant with the drive control of the LEDs 34, but the peak value of the voltage required for light irradiation can be reduced by performing the drive control of the LEDs 34 by performing the voltage control in which the current is constant.

(2) The irradiation control unit 60 of the present embodiment controls the irradiation unit 32 such that the turning-on and the turning-off of the irradiation with the plurality of LEDs 34 are repeatedly performed in a predetermined order in the sub-scanning direction X. According to the present embodiment, a peak value of a current required for light irradiation can be reduced while an influence on curing of an ink landed on the medium 22 can be suppressed.

(3) The irradiation control unit 60 of the present embodiment turns on the irradiation with another LED 34 after elapse of an interval time T1 from when the irradiation with a predetermined LED 34 is turned on, turns off the irradiation with the LED 34 after elapse of a turning-on time T2 from when the irradiation with the LED 34 is turned on, and turns on the irradiation with the LED 34 after elapse of a turning-off time T3 from when the irradiation with the LED 34 is turned off. According to the present embodiment, a peak value of a current required for light irradiation can be reduced while an influence on curing of an ink landed on the medium 22 can be suppressed.

(4) The interval time T1 of the present embodiment is shorter than each of the turning-on time T2 and the turning-off time T3, and the turning-on time T2 is longer than the turning-off time T3. According to the present embodiment, a peak value of a current required for light irradiation can be reduced while an influence on curing of an ink landed on the medium 22 can be suppressed.

(5) The irradiation control unit 60 of the present embodiment does not generate a time period in which all of the plurality of LEDs 34 are simultaneously turned off. According to the present embodiment, a peak value of a current required for light irradiation can be reduced while an influence on curing of an ink landed on the medium 22 can be suppressed.

(6) The plurality of LEDs 34 of the present embodiment are divided into a plurality of groups, and the irradiation control unit 60 controls the irradiation with the LEDs 34 for each of the groups. According to the present embodiment, a peak value of a current required for light irradiation can be reduced while an influence on curing of an ink landed on the medium 22 can be suppressed.

(7) The irradiation control unit 60 of the present embodiment turns on the irradiation with the LEDs 34 included in another group adjacent to a predetermined group after elapse of a predetermined time from when the irradiation with the LEDs 34 included in the predetermined group is turned on. According to the present embodiment, a peak value of a current required for light irradiation can be reduced while an influence on curing of an ink landed on the medium 22 can be suppressed.

### REFERENCE SIGNS LIST

10 Printing device
18 Ink ejection head (ink ejection means)
22 Medium (recording medium)
32 Irradiation unit (irradiation means)
34 LED (light irradiation element)
60 Irradiation control unit (irradiation control means)

1. A printing device comprising:
an ink ejection means for ejecting a photocurable ink onto a recording medium while relatively moving with respect to the recording medium in a first direction; and
an irradiation means for irradiating the recording medium with light while relatively moving together with the ink ejection means,
wherein the irradiation means includes a plurality of light irradiation elements arranged in a second direction intersecting with the first direction, and
wherein the printing device further comprises an irradiation control means for controlling the irradiation means such that turning-on and turning-off of irradiation with the plurality of light irradiation elements are repeatedly performed in a predetermined order during one cycle in which the ink ejection means and the irradiation means relatively move in the first direction.

2. The printing device as set forth in claim 1, wherein the irradiation control means controls the irradiation means such that turning-on and turning-off of the irradiation with the plurality of light irradiation elements are repeatedly performed in a predetermined order in the second direction.

3. The printing device as set forth in claim 1, wherein the irradiation control means
turns on irradiation with another light irradiation element after elapse of a first time from when irradiation with a predetermined light irradiation element is turned on,
turns off the irradiation with the predetermined light irradiation element after elapse of a second time from when the irradiation with the predetermined light irradiation element is turned on, and
turns on the irradiation with the predetermined light irradiation element after elapse of a third time from when the irradiation with the predetermined light irradiation element is turned off.

4. The printing device as set forth in claim 3,
wherein the first time is shorter than each of the second time and the third time, and
wherein the second time is longer than the third time.

5. The printing device as set forth in claim 1, wherein the irradiation control means does not generate a time period in which all of the plurality of light irradiation elements are simultaneously turned off.

6. The printing device as set forth in claim 1,
wherein the plurality of light irradiation elements are divided into a plurality of groups, and
wherein the irradiation control means controls the irradiation with the light irradiation elements for each of the groups.

7. The printing device as set forth in claim 6, wherein the irradiation control means turns on the irradiation with the light irradiation elements included in another group adjacent to a predetermined group after elapse of a predetermined time from when the irradiation with the light irradiation elements included in the predetermined group is turned on.

8. A printing method,
wherein an ink ejection means ejects a photocurable ink onto a recording medium while relatively moving with respect to the recording medium in a first direction,
wherein an irradiation means irradiates the recording medium with light while relatively moving together with the ink ejection means,
wherein the irradiation means includes a plurality of light irradiation elements arranged in a second direction intersecting with the first direction, and
wherein the irradiation means is controlled such that turning-on and turning-off of irradiation with the plurality of light irradiation elements are repeatedly performed in a predetermined order during one cycle in which the ink ejection means and the irradiation means relatively move in the first direction.

9. The printing device as set forth in claim 2, wherein the irradiation control means
turns on irradiation with another light irradiation element after elapse of a first time from when irradiation with a predetermined light irradiation element is turned on,
turns off the irradiation with the predetermined light irradiation element after elapse of a second time from when the irradiation with the predetermined light irradiation element is turned on, and
turns on the irradiation with the predetermined light irradiation element after elapse of a third time from when the irradiation with the predetermined light irradiation element is turned off.

10. The printing device as set forth in claim 9,
wherein the first time is shorter than each of the second time and the third time, and
wherein the second time is longer than the third time.

11. The printing device as set forth in claim 2, wherein the irradiation control means does not generate a time period in which all of the plurality of light irradiation elements are simultaneously turned off.

12. The printing device as set forth in claim 2,
wherein the plurality of light irradiation elements are divided into a plurality of groups, and
wherein the irradiation control means controls the irradiation with the light irradiation elements for each of the groups.

13. The printing device as set forth in claim 12, wherein the irradiation control means turns on the irradiation with the light irradiation elements included in another group adjacent to a predetermined group after elapse of a predetermined time from when the irradiation with the light irradiation elements included in the predetermined group is turned on.
